(19) United States
(12) Patent Application Publication
(10) Pub. No.: US 2011/0255304 A1
(43) Pub. Date: Oct. 20, 2011

(54) SURFACE LIGHT SOURCE ELEMENT AND IMAGE DISPLAY INCLUDING THE SAME

(75) Inventor: Seiji Kinoshita, Ibaraki (JP)

(73) Assignee: Kuraray Co., Ltd., Kurashiki-shi, OKAYAMA (JP)

(21) Appl. No.: 13/125,678

(22) PCT Filed: Oct. 21, 2009
(86) PCT No.: PCT/JP2009/068144

§ 371 Date: Jul. 8, 2011

(30) Foreign Application Priority Data
Oct. 22, 2008 (JP) 2008-272403

(51) Int. Cl. F21V 7/22

(52) U.S. Cl. 362/607

(57) ABSTRACT

The present invention is objected to improve brightness in a front direction in a surface light source element including a light-guiding plate having a primary light source at least one side surface, a reflector and a prism sheet. In the surface light source element using the light-guiding plate (1) including a concave stripe (9) on a bottom surface (7) side, in order to emit light in the front direction after passing through the prism sheet of an optical sheet above the light-guiding plate (1), an average angularity R of an inclined surface of the concave stripe (9) to the bottom surface of the light-guiding plate is within the range described by the following condition,

R≦[π/2−sin⁻¹(0.422/n_{LGP})]/2

R≧sin⁻¹(1/n_{LGP})−sin⁻¹(0.643/n_{LGP})
R: the average angularity (radian) to the bottom surface of the light-guiding plate (1),
n_{LGP}: a refractive index of a base material of the light guiding plate (1).

### TECHNICAL FIELD

The present invention relates to an edge-light type surface light source element having a plurality of primary light sources, and an image display using the same, more specifically to an edge-light type surface light source element used for liquid crystal displays for which a high image quality is desired, illuminated signs, or the like, and to an image display using the edge-light type surface light source element.

### BACKGROUND ART

Two types of elements, namely, beneath-light type and edge-light type surface light source elements for an image display are known.

The beneath-light type surface light source element includes a plate-like member provided with a light-emitting surface and a plurality of primary light sources disposed on a back surface of the plate-like member. This type has a characteristic in that it is easy to be large in size because the light sources are disposed on the back surface, opposite the light-emitting surface, and the element is widely used as a display for a television having a liquid crystal display. Generally, the plate-like member on which the light-emitting surface is provided is structured by a plurality of optical sheets referred to as diffusion plates, prism sheets, diffusion sheets or the like.

On the other hand, the edge-light type surface-light source element has a characteristic such that it is possible to have a thickness thinner than that of the beneath-light type surface light source element because a plurality of primary light sources are disposed on a side surface of a light-guiding plate, and the element is widely used as displays such as mobile notebook computers, monitors or the like. Light emitted from the primary light sources enters a transparent plate-like light-guiding plate made of transparent polymer molecule such as PMMA (polymethylmethacrylate) or the like, bends, is transmitted in the light-guiding plate and emitted from an exit surface which is one of two principle surfaces of the light-guiding plate toward a liquid crystal panel. An optical sheet referred to as a diffusion sheet, a prism sheet or a reflective polarizing film configured to collect light emitted from the light-guiding plate and accomplish a high brightness is also used.

Printing of white dots is applied onto a reflection surface which is one of the two principle surfaces of the transparent plate-like light-guiding plate to improve light use efficiency, and a size and a density of the dots are adjusted so that brightness distribution in the light-emitting surface of the surface light source element in a direction of viewing is equalized. Similarly, a light-guiding plate is used in which a pattern including dots each having 0.1 to 0.5 mm in size and a disc-like shape having 0.01 to 0.05 mm in thickness is formed, and a top surface of the pattern is roughened is directly provided on the reflection surface of the light-guiding plate.

There is proposed a light-guiding plate (Patent Documents 1 to 3) provided with a pattern having light use efficiency higher than that of the printing type light-guiding plate.

For example, Patent Document 3 discloses a light-guiding plate including concave or convex stripes each having a trapezoidal shape in section, provided on at least one of an exit surface and a bottom surface. By these convex or concave stripes, light that enters the light-guiding plate through an incident end surface is taken in the bottom surface, and the reflection light is effectively reflected in the direction of the exit surface. In addition, by emitting light from the exit surface through trapezoidal convex stripes provided on the exit surface by use of the light-guiding body, it is possible to emit light that enters the light-guiding plate in the direction perpendicular to the incident end surface with an angle near a front direction, so that a prism sheet can be omitted.
Patent Document 1: Japanese Patent Application Publication No.H10-282342
Patent Document 2: Japanese Patent Application Publication No.2003-114432
Patent Document 3: International Application Publication No.WO2006/013969A1

### DISCLOSURE OF THE INVENTION

### Problems to be Solved by the Invention

In recent years, large-size, lightweight, thinned, and low power image displays for television are strongly desired in the market. However, the image displays still do not have the required brightness after these requirements are satisfied. For this reason, it is considered to incorporate a prism sheet which is a commercial film for improving brightness in the light-guiding plate described in Patent Document 3, but even so, sufficient performance can not be obtained.

An object of the present invention is to provide a surface light source element capable of illuminating brightly a viewing direction even though a size of a surface light source element is increased or a thickness of a surface light source element is decreased by combining a prism sheet which is generally used in a surface light source element and a light-guiding plate of the present invention and emitting light emitted from a primary light source to be concentrated in an effective area and an effective viewing direction, and an image display having the surface light source element.

### Solution to Problems

A first invention provides an edge-light type surface light source element, including: a light-guiding plate including a side surface having at least one primary light source, an exit surface, a bottom surface opposite to the exit surface, and an incident end surface from which light emitted from the primary light source provided in the side surface enters; a reflector provided on the bottom surface side of the light guiding plate, and configured to reflect light; and an optical sheet provided on the exit surface side of the light-guiding plate, wherein the optical sheets include at least one prism sheet, an exit surface of a prism sheet closest to the exit surface of the light-guiding plate includes a convex stripe, the convex stripe is arranged parallel to an X-axis, if a normal line of an X-Y plane formed by an X-axis and a Y-axis orthogonal to the X-axis is a Z-axis, the primary light source is arranged parallel to the X-axis, the reflector, the light-guiding plate and the optical sheet are arranged parallel to the X-Y plane, and the reflector, the light-guiding plate and the optical sheet are arranged in order in the Z-axis direction, the incident end surface of the light-guiding plate is parallel to the X-Z plane, the bottom surface includes a pattern having a plurality of concave stripes parallel to the X-axis, and each of the concave stripes includes an inclined surface parallel to the X-axis on the incident end surface side, and an angularity R of the inclined surface to the bottom surface of the light-guiding plate satisfies the following conditions,

R≦[π/2−sin⁻¹ [{sin(θ_{MIN})}/n_{LGP}]]/2 (1)

≦{π/2−sin⁻¹(0.422/n_{LGP})}/2 (2)

R≧θc−sin⁻¹{(sin θ_{MAX})/n_{LGP}} (3)

≧sin⁻¹(1/n_{LGP})−sin⁻¹(0.643/n_{LGP}) (4)

R: the average angularity (radian) to the bottom surface of the light-guiding plate,

θ_{MIN}: the minimum value of the incident angle required for emitting near the front direction after passing through the prism sheet closest to the exit surface of the light-guiding plate, generally, 0.436 radian. (25°),

θ_{MAX}: the maximum value of the incident angle required for increasing light emitting in the front direction after passing through the prism sheet closest to the exit surface of the light-guiding plate, generally, 0.698 radian (40°),

n_{LGP}: a reflective index of a base material of the light-guiding plate, and

θ_{c}: a total reflection critical angle of the base material of the light-guiding plate, {sin⁻¹(1/n_{LGP})}.

A second invention provides the above surface light source element, wherein the primary light source is arranged in each of the opposite two incident end surfaces, and each of the plurality of concave stripes has the inclined surface parallel to the X-axis relative to the two incident end surfaces.

A third invention provides the above surface light source element, wherein the concave stripe formed on the bottom surface of the light-guiding plate includes a V shape in section.

A fourth invention provides the above surface light source element, wherein the concave stripe formed on the bottom surface of the light-guiding plate includes a trapezoidal shape in section.

A fifth invention provides the above surface light source element, wherein the exit surface of the light-guiding plate includes a pattern having a plurality of convex stripes parallel to the Y-axis.

A sixth invention provides the above surface light source element, wherein the convex stripe formed on the exit surface of the light-guiding plate includes a trapezoidal shape in section.

A seventh invention provides the above surface light source element, wherein the optical sheets include a diffusion sheet, a prisms sheet, and a diffusion sheet sequentially arranged above the exit surface of the light-guiding plate.

An eighth invention provides the above surface light source element, wherein the optical sheets include a diffusion sheet, a prism sheet, a reflection type polarization film sequentially arranged above the exit surface of the light-guiding plate.

A ninth invention provides an image display comprising a transmission-type display element on the exit surface side of the surface light source element.

### Advantageous Effects of Invention

The first invention includes the function of which deflecting light in the required front direction after passing through the optical sheet provided above the exit surface of the light-guiding plate. Especially, in order to improve the front direction brightness of the surface light source element by using the prism sheet, it is necessary to limit the incident angle of the incident light to the prism sheet. More specifically, in the constitution of the present invention, the average angularity of the inclined surface of the concave stripe provided on the bottom surface of the light-guiding plate is set within a limited range, so that the effect of the present invention is achieved at a maximum.

As the second invention, if the primary light sources are disposed on the opposite two incident end surfaces of the light-guiding plate, respectively, it is possible to achieve high incident efficiency of light from the primary light sources into the light-guiding plate, and reduce the thickness of the light-guiding plate when having the same brightness performance because light enters the two incident end surfaces, thus to thin the surface light source element, compared with two primary light sources provided on one incident end surface. In addition, because the incident end surfaces are provided on the both ends of the light-guiding plate, surface brightness distribution in a light-emitting area on the central line between one incident end surface and another incident end surface opposite to the one incident end surface may be adjusted. Thereby, it is possible to achieve easily equalization of surface brightness distribution, compared with a light-guiding plate having one incident end surface.

As the third invention, if each of the concave stripes provided in the bottom surface of the light-guiding plate has a V-shape in section, of lights guided in the light-guiding plate, the light that directly enters the inclined surface of the V-shaped concave stripe on the incident end surface side totally reflects, so that it is possible to emit the light with an angle very near the front direction after passing through the optical sheet provided on the exit surface side of the light-guiding plate without losing energy, and therefore increase brightness in the front direction.

As the fourth invention, if each of the concave stripes provided in the bottom surface of the light-guiding plate has a trapezoidal shape in section, it is possible to increase brightness in the front direction, similar to the V-shaped concave stripes and achieve high production efficiency, when making the light-guiding plate by an injection mold process, because the light-guiding plate has excellent mold-release property to a mold.

As the fifth invention, when the convex stripes are formed on the exit surface of the light-guiding plate, if at least one incident end surface of the light-guiding plate is disposed parallel to the X-axis, the convex stripes provided on the exit surface of the light-guiding plate are disposed parallel to the Y-axis, a direction of the X axis is a horizontal direction, and a direction of the Y-axis is an up and down direction, because light reflected on the bottom surface of the light-guiding plate can be deflected by the convex stripes arranged on the exit surface in the horizontal direction, it is possible to improve view angle characteristic.

Moreover, if the convex stripes are arranged on the exit surface of the light-guiding plate parallel to the Y-axis, of the traveling light inside the light-guiding plate, the light totally reflected by the inclined surfaces of the convex stripes directly enters the inclined surfaces of the concave stripes on the incident end side and totally reflects, so that the light emits from the exit surface of the light-guiding plate without loosing energy, and the light is added as a component of the front direction after passing through the optical sheet, and thus, the brightness of the front direction can be improved.

Especially, as the sixth invention, if the convex stripes each having a trapezoidal shape in section parallel to the plane formed by the X-axis and the Z-axis are arranged such that the longitudinal direction of the convex stripes becomes parallel to the Y-axis, in the exit surface of the light-guiding plate and the bottom surface opposite to the exit surface, a part of the light which travels while totally reflecting in the plane formed by the X-axis and the Y-axis and the plane parallel to that plane is totally reflected by the concave stripes arranged in the bottom surface of the light-guiding plate, and the light near the front direction can be emitted after passing through the optical sheet provided on the exit surface side of the light-guiding plate from the surface constituting the trapezoidal convex stripes. Furthermore, in the exit surface of the light-guiding plate and the bottom surface opposite to that exit surface, of the light which travels while totally reflecting in the plane formed by the X-axis and the Y-axis and the plane parallel to that plane, another part of the light is deflected by being totally reflected by the inclined surfaces of the trapezoidal convex stripes, so that the light is totally reflected by the concave stripes provided on the bottom surface at an angle which is the same as that of the traveling light, and thus, high brightness can be obtained in the front direction after passing through the optical sheet provided on the exit surface side of the light-guiding plate.

As the seventh invention, if the optical sheet of the surface light source element sequentially includes above the exit surface of the light-guiding plate the diffusion sheet, the prism sheet and the diffusion sheet, the light emitted from the light-guiding plate is adjusted such that the angle dependence of the emission light is gradually-changed by the diffusion sheet above the light-guiding plate, so that the garish is eased and the image quality is improved. Moreover, the incident light component which enters from the bottom surface of the prism sheet provided above the diffusion sheet and is deflected in the front direction by the prism on the exit surface can be increased, so that the brightness of the front direction can be improved. Furthermore, by using the diffusion sheet in which the diffusion performance is set to lower, the wear and the breakage of the apex angle of the prism sheet can be prevented, so that the image quality can be improved.

As the eighth invention, if the optical sheet of the surface light source element sequentially includes the diffusion sheet, the prism sheet and the reflection type polarization sheet above the exit surface of the light-guiding plate, the light emitted from the light-guiding plate has the same effect as Claim 7 until the light emits from the prism sheet, and the reflection type polarization film provided above the prism sheet polarizes and separates the light entering the polarization film from the below, reflects the polarized light without passing through the polarization film of the liquid display element, and returns the light downwards, so as to have a function of reusing the polarized light, so that the brightness of the front direction can be improved when disposing the liquid display element above the surface light source element.

As described above, in the light-guiding plate of the surface light source element of the present invention, the concave stripes are arranged in predetermined positions in the bottom surface opposite to the exit surface, so that the brightness as seen on the exit surface from the front can be improved. If the convex stripes are arranged in the exit surface, the emission light from the light-guiding plate can be increased, and the emission direction can be controlled, so that the image display having high brightness and a good viewing angle feature can be provided.

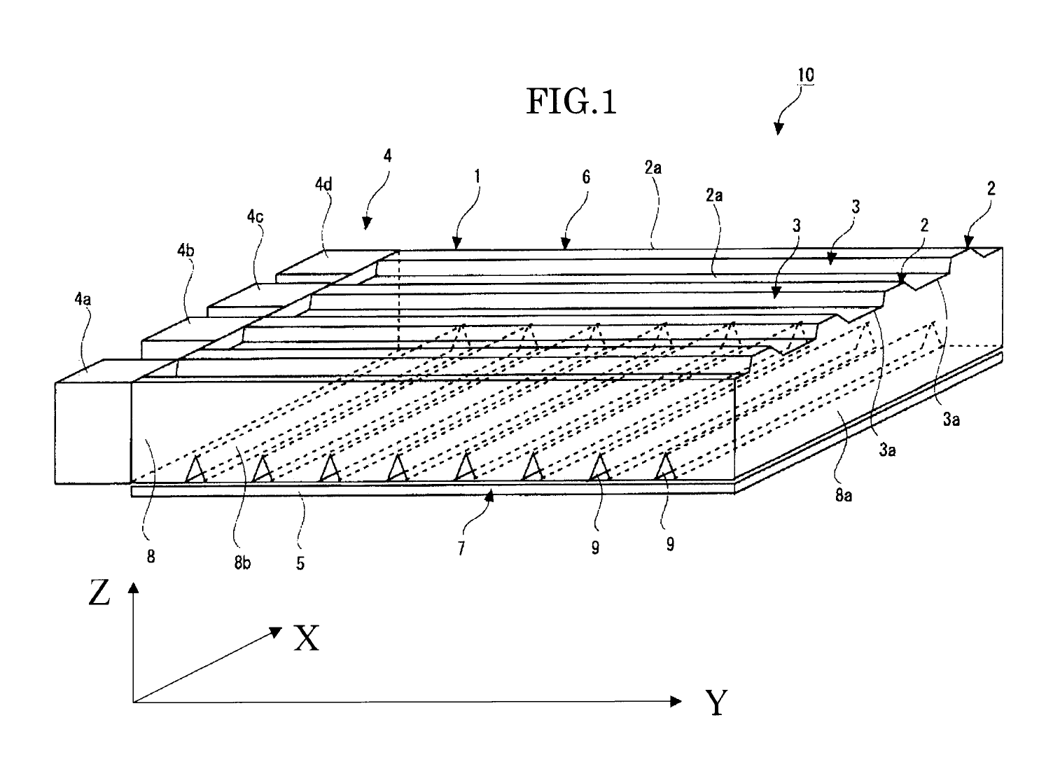

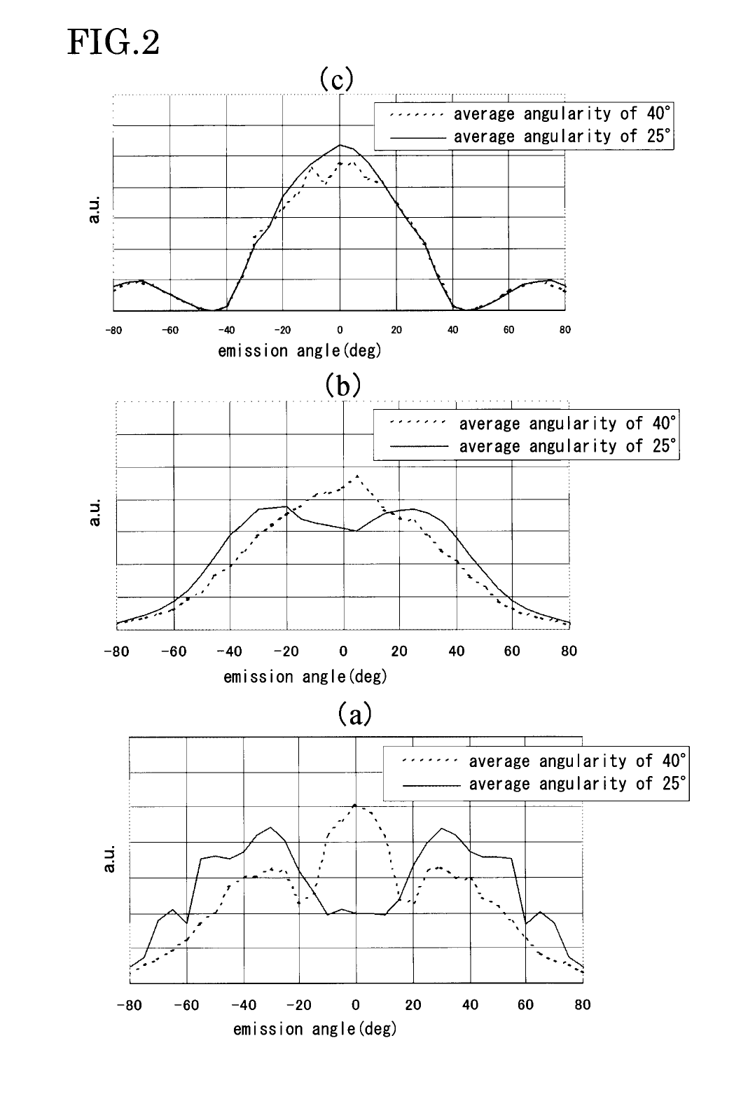

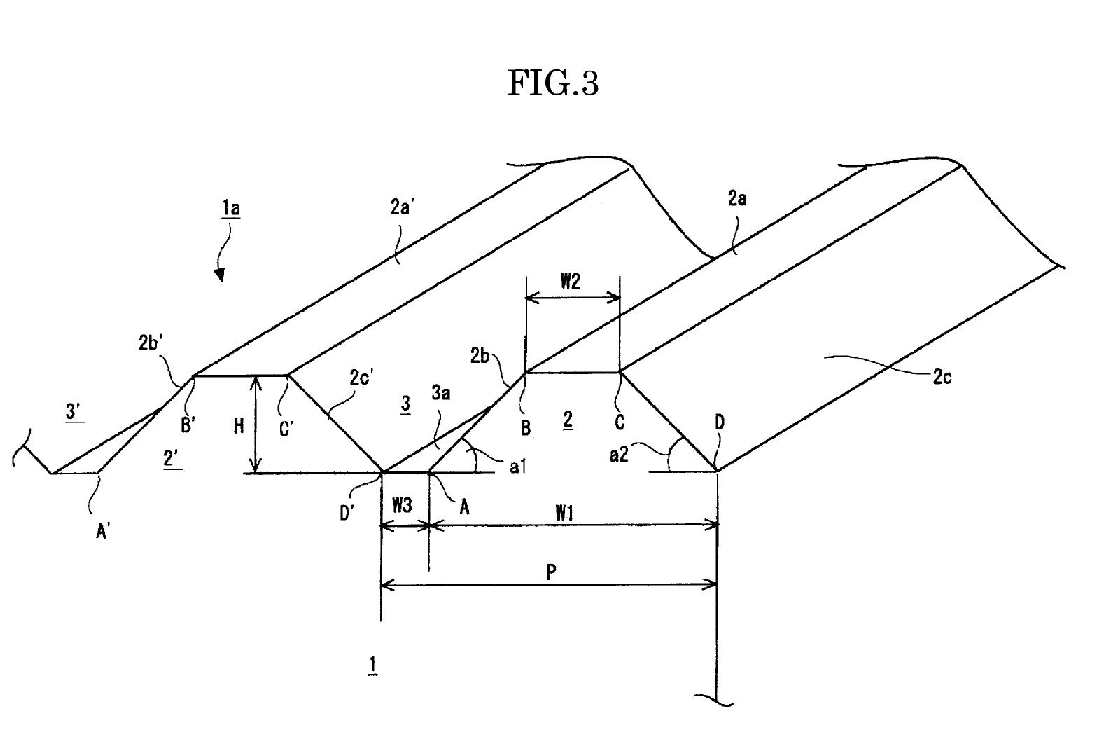

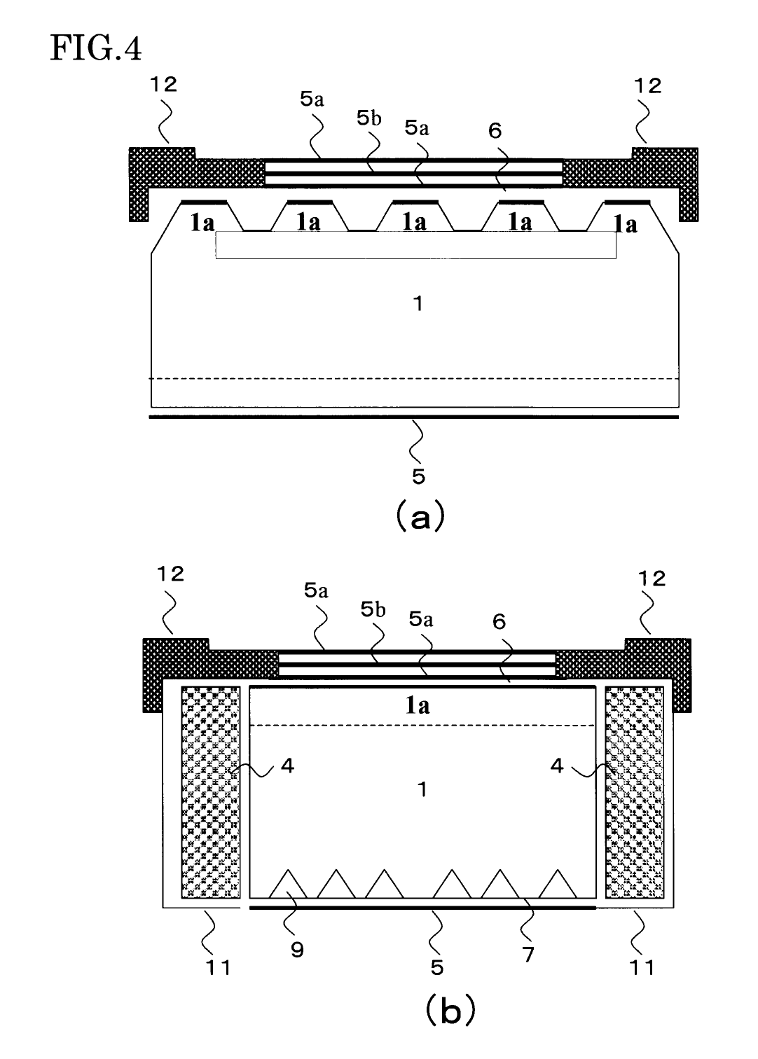

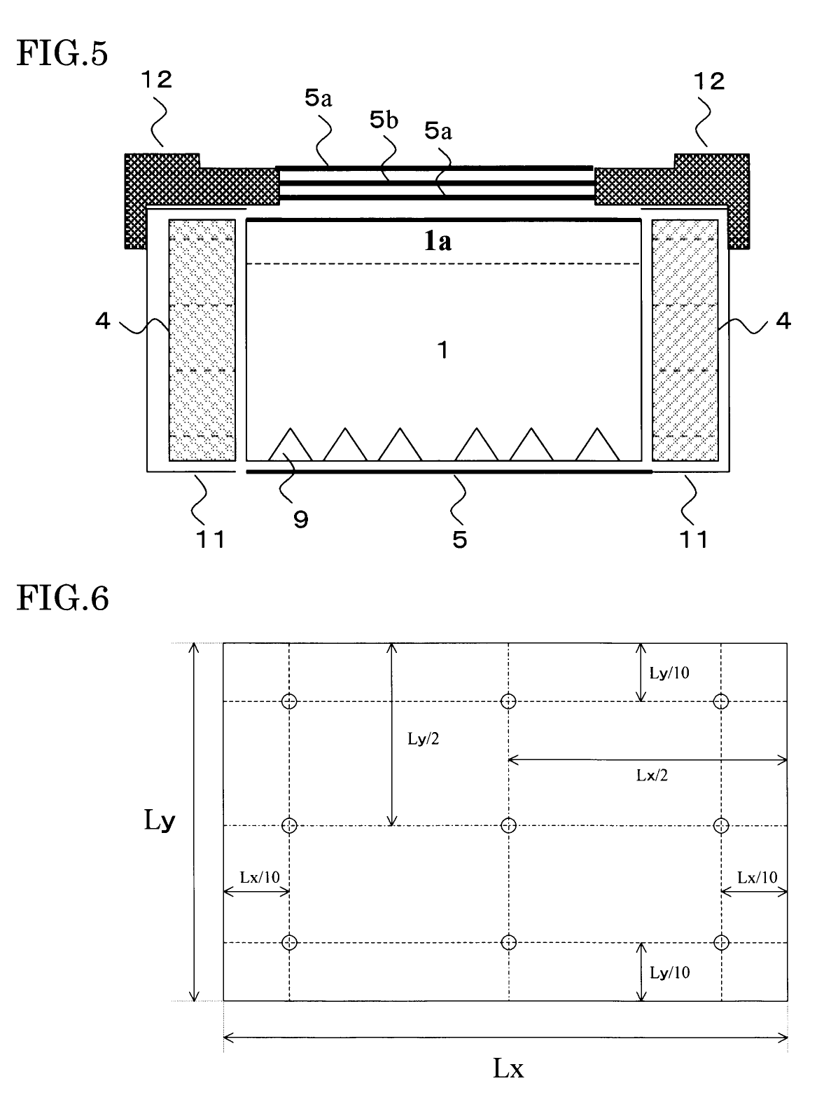

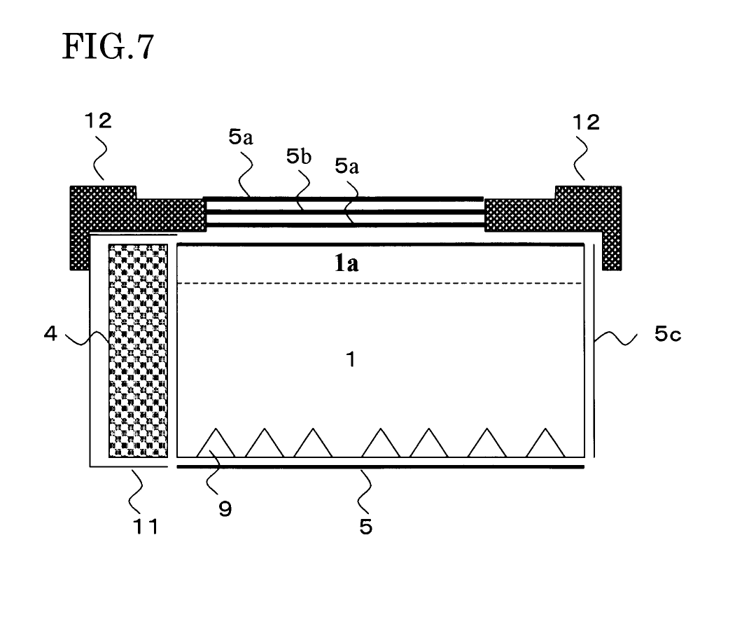

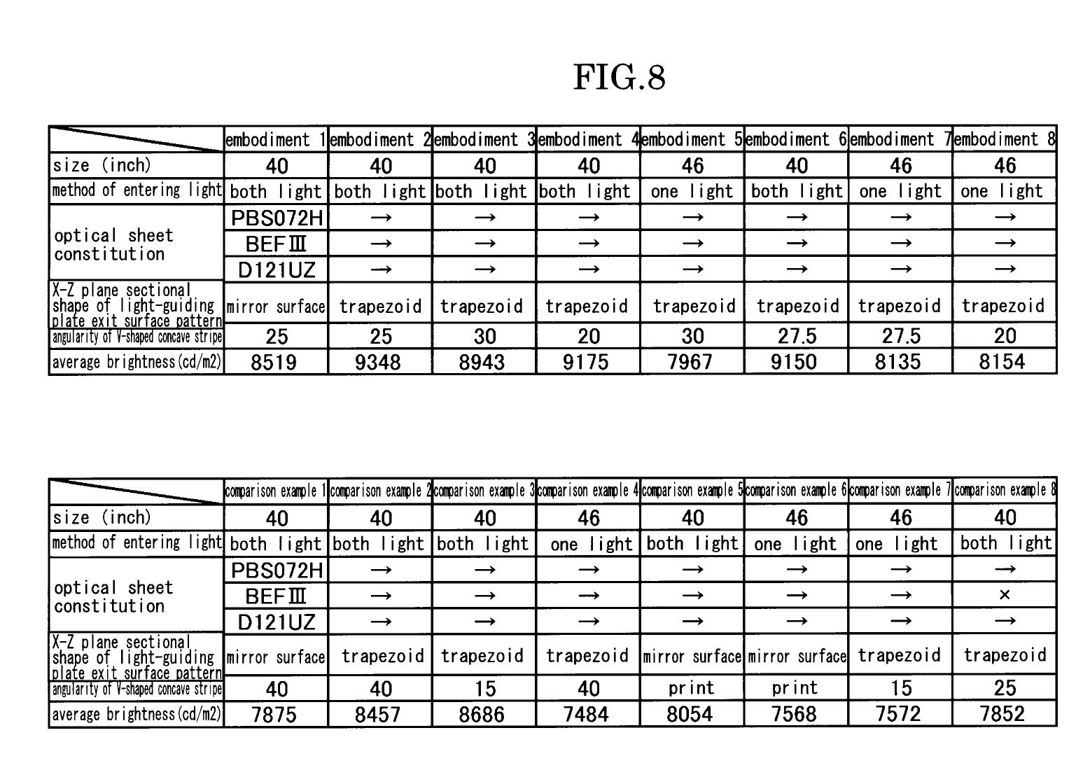

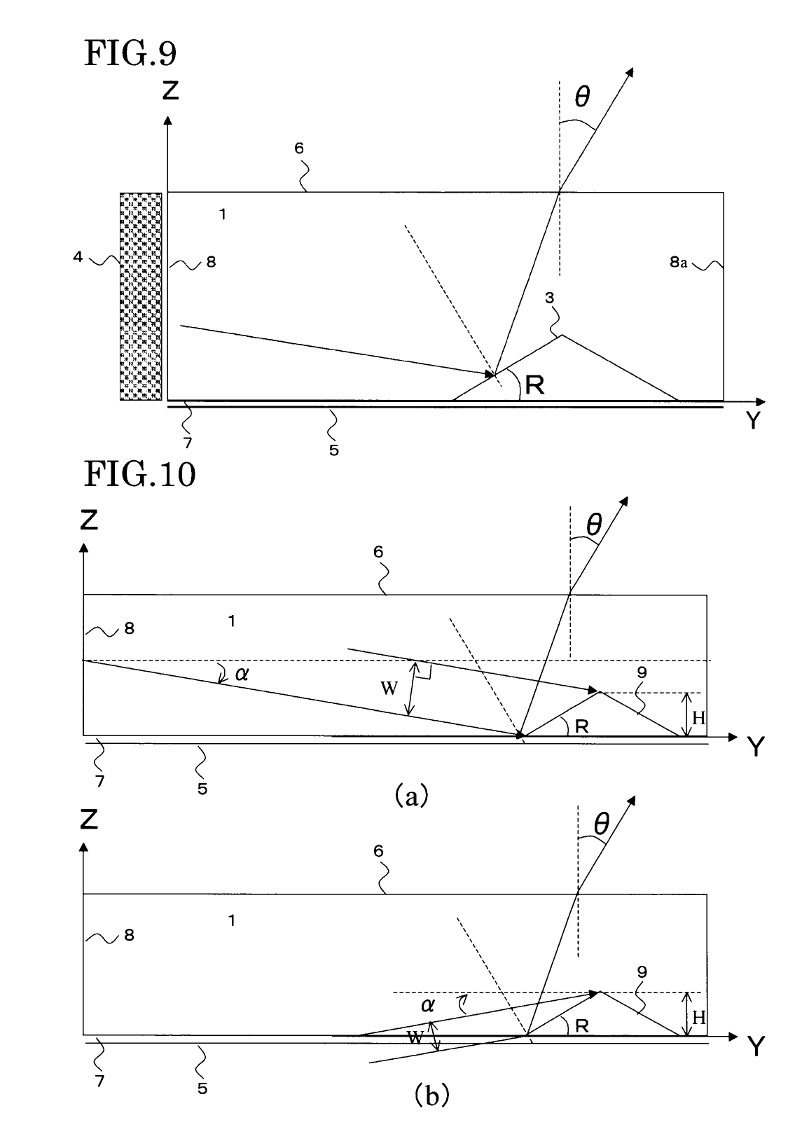

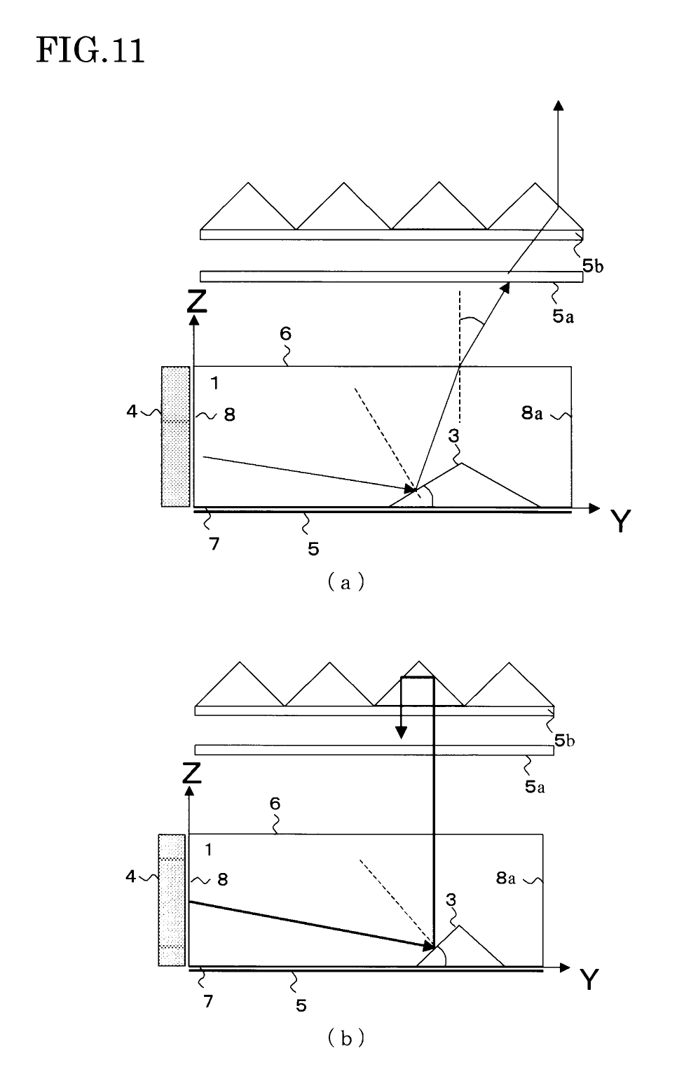

### BRIEF DESCRIPTION OF DRAWINGS

[FIG. 1] is a perspective view illustrating one example of a surface light source element according to the present invention.

[FIG. 2] (a) is a view illustrating angular brightness distribution of light emitted from an exit surface of a light-guiding plate in the up and down direction in the present invention; (b) is a view illustrating angular brightness distribution of light emitted from a diffusion sheet on the exit surface of the light-guiding plate in the up and down direction in the present invention; (c) is a view illustrating angular brightness distribution of light emitted from a prism sheet on the exit surface of the light-guiding plate in the up and down direction in the present invention.

[FIG. 3] is a schematic view describing trapezoidal convex stripes provided on the exit surface of the light-guiding plate included in the surface light source element according to the present invention.

[FIG. 4] is a schematic view illustrating one example of the surface light source element according to the present invention, wherein (a) and (b) are an X-Z sectional view and a Y-Z sectional view which pass through a central point of the surface light source element, respectively.

[FIG. 5] is a schematic view illustrating a constitution of the surface light source element in embodiments and comparison examples of the present invention.

[FIG. 6] is view illustrating measuring points for evaluating brightness uniformity in the embodiments and the comparison examples of the present invention.

[FIG. 7] is a schematic view illustrating a constitution of the surface light source element in embodiments and the comparison examples of the present invention.

[FIG. 8] is a table illustrating experimental results in the embodiments and the comparison examples of the present invention.

[FIG. 9] is a view illustrating a typical light trail of emission light of the light-guiding plate provided in the surface light source element of the present invention.

[FIG. 10] is a view illustrating a state in which the light enters an inclined surface of the concave stripe provided in the bottom surface in the light-guiding plate in the present invention.

[FIG. 11] (a) is a view illustrating a typical light trail of the light-guiding plate, a diffusion sheet and a prism sheet when the angle of the bottom surface and the inclined surface of the concave stripe provided in the bottom surface of the light-guiding plate of the present invention is 25°; (b) is a view illustrating a typical light trail of the light-guiding plate, the diffusion sheet and the prism sheet when the angle of the bottom surface of the inclined surface of the concave stripe provided in the bottom surface of the light-guiding plate of the present invention is 40°.

### DESCRIPTION OF NUMERAL NUMBERS

1: light-guiding plate
2: convex stripes
3: concave stripes
4: primary light source
4a: light-emitting unit
5: reflection sheet
5a: diffusion sheet
5b: prism sheet
5c: mirror reflection sheet
6: exit surface
7: bottom surface
8: incident end surface (side surface)
8a: reflection and incident end surface (side surface)
8b: reflection end surface (side surface)
9: V-shaped concave stripes
10: surface light source element
11: light source reflector
12: supporting frame
13: metallic frame

### DESCRIPTION OF EMBODIMENT

A best mode for carrying out the invention will be described hereinafter. Here, in drawings as mentioned hereinafter, schematic drawings in which reduction scales of length and width direction sizes of parts are arbitrarily changed are used for convenience of description.

First, a surface light source element according to the present invention is generally structured by a light-guiding plate which comprises a flat plate-like transparent structure made of a transparent resin material or the like, a primary light source disposed on a side surface of the light-guiding plate and a reflection sheet disposed on a lower surface of the light-guiding plate.

The light-guiding plate can be structured by transparent resin having a high light transmission ratio. As the transparent resin which can be used, for example, methacryl resin, acrylate resin, polycarbonate resin, polyester resin, cyclic polyolefin resin or the like can widely be adopted.

The light-guiding plate is provided at one surface thereof with an exit surface and with a bottom surface disposed opposite to the exit surface. At least one side surface of the light-guiding plate is provided with the primary light source. This side surface is formed as an incident end surface.

In the present invention, the incident end surface may be provided in at least one place, but a plurality of incident end surfaces may be provided in a plurality of places. If the incident end surface is provided in one place, reflection end surfaces are preferably provided on side surfaces of the light-guiding plate except for the incident end surface.

In a typical embodiment in which incident end surfaces are provided in two places, primary light sources are provided opposite side surfaces of the light-guiding plate, in this case, reflection end surfaces are provided on both side surfaces of the opposite side surfaces on which the primary light sources are disposed. It is necessary to satisfy a condition in which the incident end surfaces provided in the two places are parallel with concave stripes provided in the bottom surface, and arranged to be perpendicular to convex stripes if the convex stripes are provided on the exit surface.

The primary light source is disposed to face the incident end surface. Any light sources can be used as the primary light source. A linear light source such as a cold-cathode tube or fluorescent tube may be used, and a plurality of point light sources such as a plurality of LED light sources linearly arranged may be used.

In the present invention, a reflector configured to reflect light is provided in a side contacting with the bottom surface of the light-guiding plate and has a function to allow light emitted from the bottom surface of the light-guiding plate to enter the light-guiding plate again. It is preferable for the reflector to have a reflectance ratio of 95% or more to acquire high light use efficiency. A metallic foil such as aluminum, silver, or stainless, white painting, foam PET (polyethylene terephthalate) resin or the like may be used as a material of the reflector or plate. It is preferable for the reflector to be made of a material having a high reflectance ratio to improve light use efficiency. Silver, foam PET or the like is used for the material. It is preferable for the reflector to be made of a material to perform diffusion reflection to improve brightness uniformity. A foam PET or the like is used for the material.

As a typical example of the prism sheet provided in the surface light source element of the present invention includes BEFII made by Sumitomo 3M Ltd. Convex stripe prisms each having 90° in apex angle and 0.025 mm in height are closely arranged on a PET film by 2P resin. In addition, BEFIII made by Sumitomo 3M Ltd. has an effect of diffusing light that enters the sheet by fluctuating in a minute scale the convex stripes each having 90° in apex angle and about 0.025 mm in height in the height direction by 2P resin on the PET film, so that an image quality is improved.

The light-guiding plate provided in the surface light source element of the present invention includes on the bottom surface thereof the concave stripes formed at predetermined pitches. These concave stripes are formed such that the concave portions in section extend in one direction. The cross-section shape of these concave stripes can by any desired shape such as a triangular shape, a wedge-like shape, other polygonal shape, an undulate shape, a half-ellipsoidal shape or the like, but it is preferable for an average angularity of the inclined surface of the concave stripe on the primary light source side relative to the bottom surface to be substantially equal.

If the angularity R of the inclined surface of the concave portion of the light-guiding plate to the bottom surface satisfies the following conditions (1), (2), the light can be deflected in a required front direction after passing through the optical sheet arranged on the exit surface of the light-guiding plate.

R≦[π/2−sin⁻¹ [{sin(θ_{MIN})}/n_{LGP}]]/2 (1)

R≧θc−sin⁻¹{(sin θ_{MAX})/n_{LGP}} (3)

R is an average angularity (radian) to the bottom surface of the light-guiding plate,

θ_{MIN} is the minimum value of the incident angle required for emitting near the front direction after passing through the prism sheet closest to the exit surface of the light-guiding plate, generally, 0.436 radian. (25°),

θ_{MAX} is the maximum value of the incident angle required for increasing light emitting in the front direction after passing through the prism sheet closest to the exit surface of the light-guiding plate, generally, 0.698 radian (40°),

n_{LGP} is a reflective index of the base material of the light-guiding plate, and

θ_{c} is a total reflection critical angle of the base material of the light-guiding plate, {sin⁻¹(1/n_{LGP})}.

If the prism sheet on the light-guiding plate has 90° in apex angle as BEFII made by Sumitomo 3M Ltd., the incident angle suitable for emitting in the front direction is near 30° converted into degree display in the substantial up and down direction. In this case, when the convex stripes on the exit surface side of the sheet are arranged parallel to the X-axis, the X-axis direction is the horizontal direction and the Y-axis direction orthogonal to the X-axis direction is the up and down direction. Similarly, if the apex angle of the convex stripe prisms provided in the prism sheet on the exit surface side is 100°, the incident angle is near 25° converted into degree display in the substantial up and down direction. Consequently, θ_{MIN} in the above condition (1) is 25° (0.436 radian). Accordingly, the above condition (1) becomes the following condition (2).

R≦[π/2−sin⁻¹ [{sin(0.436)}/n_{LGP}]]/2≦{π/2−sin⁻¹(0.422/n_{LGP})}/2 (2)

A desirable range of the average angularity of the concave stripe provided on the bottom surface of the light-guiding plate will be described with an example using acrylic resin having high transparency as the base material of the light-guiding plate as one example. If BEFII is used for the prism sheet on the light-guiding plate, θ_{MIN} is 30° in degree display and n_{LGP} is 1.49, so that the right side of the condition (2) becomes 35.2°. If the average angularity to the bottom surface of the light-guiding plate is set to be larger than 35.2°, the light having an angle closer to the front direction from the exit surface of the light-guiding plate is increased, so that the light emitted at an angle closer to the front direction from the exit surface of the light-guiding plate goes back to the light-guiding plate side when the prism sheet is disposed above the exit surface of the light-guiding plate, and it becomes difficult to increase the emission light of the surface light source element.

On the other hand, if the incident angle to the prism sheet becomes larger than 40° in degree display, it becomes difficult to increase emission light to the front direction after passing through the prism sheet. For this reason, in order to emit from the exit surface of the light-guiding plate more light totally reflected by the inclined surfaces of the concave stripes arranged on the bottom surface of the light-guiding plate within 40°, the average angularity R to the bottom surface of the light-guiding plate is obtained by substituting 40° (0.698 radian) as θ_{MAX} in the above condition (3). Accordingly, the above condition (3) becomes the following condition (4).

R≧θc−sin⁻¹{(0.698)/n_{LGP}}≧sin⁻¹(1/n_{LGP})−sin⁻¹(0.643/n_{LGP}) (4)

Similar to the above, if the base material is acrylic resin, the refractive index n_{LGP} is 1.49, so that the right side of the condition (4) becomes 16.6°. If the average angularity to the bottom surface of the light-guiding plate is set to be smaller than 16.6°, a light ratio entering at 40° or more to the prism sheet is increased, so that it becomes difficult to deflect the light in the front direction by the prism.

In this case, the concave stripe formed on the bottom surface may have a height which gradually increases with the increasing distance from the primary light source, or may have a shape which gradually changes with the increasing distance from the primary light source. This constitution in which the shape is gradually changed includes a case in which the concave stripe has a trapezoidal shape in section and a case in which the length of the upper bottom and the length of the lower bottom of the trapezoidal shape gradually differ while maintaining the angle of the inclined surface of the trapezoidal concave stripe to the bottom surface at a constant. By these constitutions, the uniformity of the brightness in the surface can be further improved.

Namely, it is preferable for the range of R to be within the range of 20° or more and 32.5° or below (115°≦apex angle≦140°) in terms of a good viewing angle feature. It is more preferable for the range of R to be within the range of 22.5° or more and 30° or below (120°≦apex angle≦135°) in terms of high brightness and a good viewing angle feature. The height is set within the range of 0.001 mm-0.1 mm, and it is preferable for the height to be within the range of 0.002 mm-0.05 mm in terms of the decrease in moiré, and it is more preferable for the height to be set within the range of 0.002 mm-0.02 mm in order to equalize the surface brightness near the primary light source.

It is desirable for the cross-section shapes of the concave stripes provided in the bottom surface to be a fixed form because the optical design can be facilitated.

If the oblique side of the cross-section surface of the concave stripe provided in the bottom surface is straight, the average angularity of the inclined surface of the concave stripe on the incident end surface side parallel to the X-axis relative to the bottom surface becomes the average value of the base angle of a general sharp angle which is the internal angle of the cross-section surface between the bottom surface and the inclined surface.

In each case, the constitution of the bottom surface is controlled such that the light reflected, deflected and scattered by using the reflection sheet and the concave stripes provided on the bottom surface of the light-guiding plate emits at a desired intensity from the exit surface, and these adjustments are combined with each other or are combined with another adjustment device.

In the light-guiding plate provided in the surface light source element of the present invention, if the cross-section surface of the concave stripe provided on the bottom surface includes a V-shape, the V-shaped concave stripes are arranged in parallel to the incident end surface. If the angularity of the V-shaped concave stripe to the bottom surface is set to be in the above-described range, the brightness of the front direction is further increased when the diffusion sheet is placed on the exit surface of the light-guiding plate further to the prism sheet.

The principle of improving the brightness of the front direction after passing through the diffusion sheet and the prism sheet disposed above the exit surface of the light-guiding plate will be described by using the case in which the V-shaped concave stripes in section are formed on the bottom surface of the light-guiding plate as one example.

One incident end surface of the light-guiding plate is arranged parallel to the X-axis, the X-axis direction is the horizontal direction and the Y-axis direction is the up and down direction.

The light that enters from the incident end face of the light-guiding plate is reflected in a predetermined direction by the V-shaped concave stripes arranged in the bottom surface of the light-guiding plate, and is emitted from the exit surface, or once comes out from the bottom surface of the light-guiding plate after passing through the V-shaped concave stripes, is diffused by the reflection sheet provided in the lower portion, again enters the light-guiding plate, and is emitted from the exit surface. However, the light to be emitted in the front direction after passing through the optical sheet on the light-guiding plate is mainly the light reflected in a predetermined direction by the former V-shaped concave stripes.

In the exit surface and the bottom surface of the light-guiding plate, the light which is transmitted while totally reflecting by the surfaces parallel to the X-Y plane may enter the inclined surface of the V-shaped concave stripe provided on the bottom surface of the light-guiding plate from above (incident angle α is positive) as illustrated in FIG. 10 (a) and may enter the V-shaped concave stripe from underneath (incident angle α is negative) as illustrated in FIG. 10 (b).

In order to direct light in the front direction after passing through the prism sheet provided in the surface light source element, it is desirable for more light to emit in the direction of about 25°-30° from the exit surface of the light-guiding plate. If the angularity of the V-shaped concave stripe to the bottom surface is set to the angularity to the bottom surface of the light-guiding plate, which is within the range required in the present invention, the case in which more light emits in the direction of about 25°-30° from the exit surface of the light-guiding plate enters the V-shaped concave stripe from above (incident angle α is positive).

On the other hand, if the angularity of the V-shaped concave stripe to the bottom surface is set to the angularity to the bottom surface of the light-guiding plate, which is out of the range required in the present invention, the case in which more light emits in the direction of about 25°-30° from the exit surface of the light-guiding plate enters the V-shaped concave stripe from underneath (incident angle α is negative).

As illustrated in FIG. 10, if the area W which enters onto the inclined surface of the V-shaped concave stripe is standardized by the height H of the V-shaped concave stripe, the following equation (5) is obtained.

W/H=sin(R+α)/sin(R) (5)

If W/H is large, more light can be emitted in a desired θ direction from the exit surface of the light-guiding plate. From the above equation (5), it is understood that if α is positive, namely, if the light enters the inclined surface of the V-shaped concave stripe from the above, W/H is increased, and more light can be emitted in a desired θ direction.

FIG. 2 (a) illustrates the angle brightness distribution of light in the up and down direction, which emits from the exit surface of the light-guiding plate when the angularity of the V-shaped concave stripe to the bottom surface of the light-guiding plate is 25°, which is within the range required in the present invention and when the angularity of the V-shaped concave stripe to the bottom surface of the light-guiding plate is 40° which is out of the range required in the present invention. If the angularity of the V-shaped concave stripe relative to the bottom surface is set to 25°, the emission in the front direction is controlled, and more light is emitted at a high emission angle of 30° or more. On the other hand, if the angularity of the V-shaped concave stripe relative to the bottom surface is set to 40°, the emission in the front direction is significantly increased.

FIG. 2(b) illustrates the angle brightness distribution of light in the up and down direction, which emits from the exit surface, when one diffusion sheet is placed above the exit surface of the light-guiding plate. If the angularity of the V-shaped concave stripe relative to the bottom surface is set to 25°, more light is emitted at 30° as the peak in the vertical direction while controlling the emission in the front direction. On the other hand, if the angularity of the V-shaped concave stripe relative to the bottom surface is set to 40°, the front direction has the peak, and the emission light in the direction of 30° of the up and down direction is decreased.

FIG. 2(c) illustrates the angle brightness distribution of the light in the up and down direction, which emits from the exit surface, when a prism sheet is placed on the diffusion sheet. If the angularity of the V-shaped concave stripe relative to the bottom surface is set to 25°, the emission in the front direction is increased compared to the case when the angularity of the V-shaped concave stripe relative to the bottom surface is set to 40°. FIG. 11(a) illustrates the main trail of the light which totally reflects by the inclined surface of the V-shaped concave stripe, emits from the exit surface of the light-guiding plate and passes through the diffusion sheet and the prism sheet, of the light which transmits in the light-guiding plate when the angularity of the V-shaped concave stripe relative to the bottom surface is set to 25°. If the angularity of the V-shaped concave stripe relative to the bottom surface is set to 25°, the light emits with the peak of 30° in the vertical direction after passing through the exit surface of the light-guiding plate and the diffusion sheet, so that the light can be emitted in the front direction after passing through the prism sheet. On the other hand, FIG. 11(b) illustrates the main trail of the light when the angularity of the V-shaped concave stripe relative to the bottom surface is set to 40°. If the angularity of the V-shaped concave stripe relative to the bottom surface is set to 40°, the light is emitted with the peak of 40° in the up and down direction after passing through the exit surface of the light-guiding plate and the diffusion sheet, so that the light is returned in the light-guiding plate direction by the prism sheet, and the emission in the front direction is decreased.

Accordingly, the angularity of the V-shaped concave stripe relative to the bottom surface is set within the range required in the present invention, more light is emitted with the peak of 30° in the up and down direction while controlling the emission in the front direction after passing through the diffusion sheet placed on the exit surface of the light-guiding plate, so that the light is effectively deflected in the front direction after passing through the prism sheet, and the improvement in the brightness is achieved.

In addition, it is possible to remove dark lines by the same principle as in the V-shape even in concave stripes each having a trapezoidal shape in section provided in the bottom surface of the light-guiding plate.

In the present invention, the convex stripes may be provided on the exit surface of the light-guiding plate at predetermined pitches. Each of the convex stripes has a trapezoidal shape as mentioned hereinafter, and may be substantially the same as or similar to that used in a conventional surface light source element.

Each of the convex stripes includes a convex portion in section configured to extend in one direction. Each of the convex stripes may have a predetermined shape such as a triangular section, a wedge-like shape, other polygonal shape, an undulate shape, a half-ellipsoidal shape or the like in section.

In the light-guiding plate included in the surface light source element according to the present invention, if each of the convex stripes provided on the exit surface has a trapezoidal shape in section, the structure is more preferable in that high front brightness in a viewing direction and a wide view angle characteristic can be acquired.

For example, in a surface of a light-guiding plate 1 as shown in FIG. 3, there is shown a portion 1a of the surface, a convex stripe 2 having a trapezoidal shape in section including apexes A, B, C and D and a convex stripe 2′ having a trapezoidal shape in section including apexes A′, B′, C′ and D′ arranged at an interval in the surface portion 1a.

Meanwhile, the trapezoidal shape according to the light-guiding plate included in the surface light source element of the present invention is not limited to a strict trapezoidal shape as illustrated in the figures. As will be clear from a description mentioned hereinafter, if the convex stripe has a configuration in which an upper bottom and a lower bottom which have a flat surface are parallel to the X-Y plane and differ in height, and inclined surfaces connecting the upper bottom and the lower bottom in a mountain shape are continuously arranged, for example, a connection portion between the upper bottom or the lower bottom and each inclined surface may be formed in a curved shape. The trapezoidal shape having the curved connection portion is preferably not only advantageous in manufacturing with relative ease but also difficult to generate failure of the connection portion. At least a part of the upper bottom or the lower bottom may have an inclination to the X-Y plane, for example, if the upper bottom and/or the lower bottom have a gentle wave-shaped part, a length direction of which corresponds to a direction of the X-axis, or concavity and convexity, high evenness of luminescence can be acquired. An average of the inclination has preferably no angle to the X-Y plane. In addition, it is desirable that a portion in which the inclination is 10° or less accounts totally for 50% or more.

Because the plurality of upper bottoms and lower bottoms exist together in the same X-Y plane, not only efficient guiding of light can be accomplished, but also there is an advantageous effect in that a stable gravity center of the light-guiding plate can be acquired, thereby industrially advantageous continuous manufacturing in an extrusion or the like can be easily accomplished.

Next, a function of the trapezoidal shape is mentioned with reference to FIG. 3. The technical terms, “upper bottom” and “lower bottom” are used, but they do not mean up and down directions and are used for convenience of description. Here, of trapezoidal parallel opposite sides, a short side is “upper bottom” and a long side is “lower bottom”. It is established in FIG. 3 that a length of a straight line AD (width of a lower bottom of the convex stripe 2) is W1, a length of a straight line BC (width of an upper bottom 2a of the convex stripe 2) is W2, a length of a straight line AD′ (width of an upper bottom 3a of a concave stripe 3) is W3, a height of the convex stripe 2 (or depth of the concave stripe 3) is H, an angle formed by the straight line AD and a straight line AB (inclined surface 2b) is a1, an angle formed by the straight line AD and a straight line DC (inclined surface 2c) is a2, and a length of a straight line DD′ is a pitch P. The pitch P is equal to a sum of the width W1 (length of the straight line AD) of the lower bottom of the convex stripe 2 and the width W3 of the upper bottom 3a of the concave stripe 3, and a sum of the width W2 (length of the straight line BC) of the upper bottom 2a of the convex stripe 2 and the width (length of the straight line BC′) of the lower bottom of the concave stripe 3.

In the exit surface of the light-guiding plate included in the surface light source element according to the present invention, by forming the sectional shape of the convex stripe 2 in a trapezoidal shape and setting an adequate width W2 to the convex stripe 2, the traveling light that enters from the incident end surface is guided to a central portion of the light-guiding plate.

In addition, in the exit surface of the light-guiding plate included in the surface light source element according to the present invention, by forming the sectional shape of the concave stripe 3 in a trapezoidal shape and setting a desired width W3 to the concave stripe 3, similar to the width W2 as mentioned above, the light that enters from the incident end surface is guided along the Y axis direction in the light-guiding plate. If the width W2 is too small and contribution of the inclined surfaces 2b and 2c is too large, it is difficult to achieve sufficiently an advantageous effect to improve brightness in a vertical direction because the light traveling in the X-axis direction is emitted from the inclined surface. Even if the width W3 is too small and contribution of the inclined surfaces 2b and 2c is too large, it is difficult to achieve sufficiently an advantageous effect to improve brightness in a vertical direction. On the contrary, if the width W2 or the width W3 is set to be much larger than the inclined surfaces 2b and 2c relatively, the contribution of the inclined surfaces 2b and 2c is less relatively, and of the traveling light in the Y-axis direction, the light totally reflected by the inclined surface is totally reflected newly by the V-groove inclined surface, the light which emits to about 25-30° in the up and down direction from the exit surface is newly generated, but it becomes difficult to sufficiently achieve the effect of improving the brightness in the up and down direction because the contribution is decreased.

In the exit surface of the light-guiding plate included in the surface light source element according to the present invention, a shape, a size, and a pitch P of each of the convex stripes 2 or concave stripes 3 are decided in consideration of a relationship among a size of the light-guiding plate 1, display performance of the surface light source element and specifications or the like. Thereby, it is possible to maintain adequately the brightness of light emitted from the exit surface of the light-guiding plate and acquire an appropriate view angle.

A general height H of the convex stripe 2 (or the concave stripe 3) is selected from the range of 0.001-0.1 mm, more preferably 0.005-0.05 mm, most preferably 0.01-0.03 mm. In addition, general inclined angles a1 and a2 are respectively selected from the range of 15°-70°, more preferable inclined angles a1 and a2 are respectively selected from the range of 15°-60°. If the view angle characteristic is especially emphasized, the inclined angles a1 and a2 are respectively selected from the range of 15°-35°, and if the brightness characteristic is especially emphasized, the inclined angles a1 and a2 are selected from the range of 35°-60°, which is the most preferable range. Also, the general width W1 of the lower bottom is selected from the range of 0.01-0.5 mm, more preferably 0.015-0.27 mm, most preferably 0.015-0.18 mm. The width W2 of the upper bottom is selected from the range of 0.001-0.5 mm, more preferably 0.001-0.1 mm, most preferably 0.005-0.05 mm. The general width W3 is selected from the range of 0.0001-0.5 mm, more preferably 0.0001-0.3 mm, most preferably 0.001-0.15 mm.

In a preferred mode of the exit surface of the light-guiding plate included in the surface light source element according to the present invention, the exit surface of the light-guiding plate 1 is characterized in that the exit surface has a trapezoidally-shaped pattern in which the widths W1, W2 and W3 are formed by maintaining a particular ratio relationship with the pitch P. That is to say, in the exit surface of the light-guiding plate 1 included in the surface light source element according to the present invention, a ratio W3/W2 of the width W3 of the upper bottom formed on the concave stripe 3 to the width W2 of the upper bottom formed on the convex stripe 2 is preferably within the range of 0.01-200, more preferably 0.02-100, and most preferably 0.1-10. In addition, the ratio of (P−W2−W3) to (W2+W3) is within the range of 0.04-400, more preferably 0.2-200, most preferably 0.3-150.

In the exit surface of the light-guiding plate included in the surface light source element according to the present invention, by maintaining the ratio of the width W3 to the width W2 in the aforementioned ranges, brightness of light emitted from the exit surface of the light-guiding plate 1 is adequately maintained, and a condition setting to acquire adequate view angle is facilitated. Here, if the ratio of the width W3 to the width W2 is within the range of 0.1-10, the brightness in the front direction is enhanced after passing through the optical sheet provided on the exit surface of the light-guiding plate.

Moreover, if the ratio of (P−W2−W3) to (W2+W3) is within a range of 0.3-150, the view angle characteristic can be ensured while controlling the decrease in the brightness of the vertical direction after passing through the optical sheet disposed on the exit surface of the light-guiding plate.

Next, an example of a surface light source element using the aforementioned light-guiding plate 1 is described with reference to FIGS. 1, 4.

The surface light source element 10 is generally composed of a light-guiding plate 1 which is a flat plate-like transparent structure made of a transparent resin or the like such as acrylate resin, light-emitting units 4a arranged on one side surface of the light-guiding plate 1, and a reflection sheet 5 disposed at a lower surface of the light-guiding plate 1. An exit surface 6 to emit light is provided on an upper surface of the light-guiding plate 1. A bottom surface 7 disposed opposite to the exit surface 6 is provided on the light-guiding plate 1.

FIG. 1 is a perspective view showing one example of the surface light source element according to the present invention. Here, in the surface light source element 10 as shown in FIG. 1, the light-emitting units 4a are arranged on the one side surface of the light-guiding plate 1. This side surface is formed in an incident end surface 8. The plurality of light-emitting units 4a arranged on the one incident end surface are formed as a primary light source 4. Both side surfaces intersecting with the incident end surface 8 are formed in reflection end surfaces 8b. A surface opposite to the incident end surface 8 is formed in a reflection and incident end surface 8a.

The surface light source element illustrated in FIG. 4 is an example of a surface light source element according to the present invention in which primary light sources are disposed on two opposite side surfaces of a light-guiding plate, and is used to display a large sized liquid crystal image display. FIGS. 4(a), 4(b) are an X-Z sectional view and a Y-Z sectional view which pass through a central point of the surface light source element, respectively.

Light source reflectors 11 in each of which light-emitting units 4a are disposed are disposed at the both side surfaces of the exit surface 6 and the bottom surface 7. A thick light-guiding plate 1 is used to sufficiently acquire an amount of light entering the light-guiding plate 1 from the light-emitting units 4a. Thereby, both side surfaces on which the light-emitting units 4a are arranged are formed in incident end surfaces 8, and both side surfaces intersecting with the incident end surfaces 8 are formed in reflection end surfaces 8b. Moreover, in the surface light source element as shown in FIG. 4, a diffusion sheet 5a is disposed above the exit surface 6. A prism sheet 5b made by Sumitomo 3M, Ltd. having a function of improving brightness is disposed above the diffusion sheet 5a. By disposing the diffusion sheet above the light-guiding plate, it is possible to make uniform adequately light emitted from the surface light source element and hence achieve high screen quality. In addition, by deflecting light in the front direction by the prism sheet, it is possible to further improve the brightness in the front direction.

In each of the surface light source elements as shown in FIGS. 1, 4, convex stripes 2 each having a trapezoidal shape in section and concave stripes 3 each having a trapezoidal shape inverted in up and down with respect to the trapezoidal shape of the convex stripe 2 are arranged alternately on the exit surface 6. Because the convex stripes 2 and the concave stripes 3 are substantially the same as the surface 1a as mentioned with reference to FIG. 3, the detailed description thereof is omitted. Consequently, a plurality of convex and concave stripes which have trapezoidal shapes in section and are perpendicular to the incident end surfaces 8 are arranged on the exit surface 6. On the other hand, a plurality of concave stripes 9 each having a V-shape in section are provided on the bottom surface 7 to be arranged parallel to the incident end surfaces 8. By adjusting pitches P of the V-shaped concave stripes 9 progressively, it is possible to adjust the distribution of an amount of light emitted from the exit surface.

Next, the surface light source element 10 structured as mentioned above is explained. Light emitted from the light-emitting units 4a that enters the light-guiding plate 1 from the incident end surface 8 of the light-guiding plate 1, and is transmitted in the longitudinal direction while repeating total reflection between the exit surface 6 and the bottom surface 7. A part of the light is guided toward the exit surface 6 by the V-shaped concave stripes 9 formed in the bottom surface 7 and the reflection sheet 5, and is collected by a prism (convex stripes 2 and concave stripes 3) having a trapezoidal shape in section formed on the exit surface 6, and emitted in a predetermined view angle.

In this way, by forming the trapezoidal-shaped prism in section on the exit surface 6, it is possible to broaden the view angle compared to a case when a V-groove prism is formed on the exit surface 6.

An image display according to the present invention is structured by disposing a light-transmitting type-display in the front direction of the surface light source element, and it is possible to display a clear image having high quality, high brightness, and high even brightness, without reducing image quality due to dark lines. Here, the image display according to the present invention includes display modules combining the surface light source element and a display element, and instruments having at least image display functions using the display modules such as personal computers or televisions.

### EMBODIMENTS

Advantageous effects of the present invention are concretely described hereinafter based on embodiments. In addition, FIG. 8 illustrates a list of the following embodiments and comparison examples.

### Embodiment 1

A mirror stamper made of SUS was used for forming a stamper (hereinafter referred to as stamper 1) on the exit surface side. On the other hand, a stamper (hereinafter referred to as stamper 2) on the bottom surface side, in which prism patterns each having 0.007 mm in height and 130° in top angle were arranged at predetermined intervals, was manufactured by directly forming V-shaped concave stripes each having 0.007 mm in height and 130° in top angle in a mold insert by a cutting process using a diamond bit, forming a nickel electroformed layer by performing direct electroforming from the cut insert, and removing the master.

As molds for transferring, the stampers 1, 2 were assembled in a mold stationary side cavity and a mold movable side cavity of an injection machine, and a light-guiding plate having a fine structure for a 40 inch-liquid crystal television was obtained by use of an injection molding process. The obtained light-guiding plate was formed to have the outside size of 900 mm×511 mm×4 mm in width, length and height, respectively. The light-guiding plate was formed to have a mirror exit surface and a bottom surface having V-shaped concave stripes. Each of the V-shaped concave stripes had the height of 0.007 mm and the average angularity R of 25° of an inclined surface corresponding to an average bottom angle in each of the concave stripes parallel to the X-axis in an incident end surface side, to the bottom surface. The pitches of the V-shaped concave stripes were changed to be gradually and gently decreased from 0.430 mm in the incident end face side to 0.196 mm in the central portion.

A multi-chip LED module (light-emitting element: 10, outside size: 13.7 mm and light-emitting length: 11.4 mm) of model No. SEP0HA6005 made by Sanken Electric Co., Ltd. was used as a light-emitting unit. In order to form a primary light source, 65 light-emitting units were directly aligned at equal intervals (13.9 mm). V-shaped concave stripes were arranged on the bottom surface of the light-guiding plate to be parallel to the X-axis. The primary light source was arranged only in the two end surfaces parallel to the X-axis. The light-emitting units were arranged in the opposite two incident end surfaces, and thus, in total, 2×65=130 light-emitting units were used.

In addition, one diffusion sheet (model No. D121UZ made by Tsujiden Co. LTD.) was disposed above the exit surface of the light-guiding plate, and a brightness-up film (model No. BEF III-90/50T-7 made by Sumitomo 3M Ltd.) was further disposed so that long sides of prisms are parallel to the X-axis, and a diffusion sheet (model No. PBS072H made by Keiwa Inc.) was further disposed on the brightness-up film.

In addition, a reflection sheet 5 (model No. E6SL made by Toray Industries, Inc.) was disposed on each of a bottom surface 7 and reflection end surfaces 8b of the light-guiding plate, and these parts were contained in a metallic frame.

A supporting frame made of polystyrene was disposed from above the metallic frame and combined to the metallic frame located on a back surface of the supporting frame. In the backlight device thus formed and illustrated in FIG. 5, brightness performance was measured by applying the current of 24V, 5A from a stabilized power supply. A brightness meter (TOPCON BM-7 made by Topcon Corporation) was used for the brightness measurement, and 9 points illustrated in FIG. 6 relative to an inside dimension of 885×497 mm of an opening area of a supporting frame 12 were measured. The evaluation by the brightness meter used the average brightness of the 9 points. As a result, the in-plane average brightness was 8519 cd/m².

### Embodiment 2

A negative type photoresist (CA3000) made by Tokyo Ohka Kogyo Co., Ltd. was applied to a cleaning glass, heated for 2 minutes by a hotplate of 110° C. and thereafter cooled to a room temperature. A photomask in which slits were provided at predetermined intervals was closely fitted to the glass substrate, rotated at a constant speed from −35° to +35° and during the rotation, UV light, 1400 mj was irradiated. After the photomask was removed, the substrate was developed. A nickel conductive film was applied to a surface of the obtained master by use of an ordinary method, and a nickel electroformed layer was formed by electroforming nickel as an electroforming metal on the nickel conducted film. In addition, a stamper (hereinafter referred to as stamper 3) on the exit surface side having trapezoidal patterns having 0.01 mm in height, a flat portion having about 0.01 mm in width on the top portion and 55° in inclined angle was made by removing the master from the nickel conducted film.

On the other hand, a stamper (hereinafter referred to as stamper 4) on the bottom surface side, in which prism patterns each having 0.007 mm in height and 130° in top angle were arranged at predetermined intervals, was made by forming V-shaped concave stripes each having the top angle of 130° and the height of 0.007 mm in a mold insert directly by use of a diamond bit through a cutting process, performing direct electroforming from the cut insert to form a nickel electroformed layer, and removing the master.

As molds for transferring, the stampers 3, 4 were assembled in a mold-stationary side cavity and a mold-movable side cavity of an injection machine, and a light-guiding plate for a 40 inch-liquid crystal television, having a fine structure was acquired through an injection forming process. The outside size of the obtained light-guiding plate was formed to have 900 mm×511 mm×4 mm in width, length and height, respectively.

The obtained light-guiding plate was formed to have an exit surface on which convex stripes each having a trapezoidal shape in section were arranged at predetermined intervals and a bottom surface in which concave stripes each having a V-shape in section were arranged at predetermined pitches. In each of the trapezoidal convex stripes provided on the exit surface, the height H was 0.01 mm, the width W2 of the top portion was 0.01 mm, the width W1 of the bottom surface was 0.024 mm, and in each of the V-shaped concave stripes provided in the bottom surface, the height was 0.007 mm, and the average angularity R of an inclined surface corresponding to an average bottom angle in each of the concave stripes parallel to the X-axis in an incident end surface side, to the bottom surface was 25°. The pitches were changed to be gradually and gently decreased from 0.446 mm in the incident end surface to 0.179 mm in the central portion. The light-guiding plate was assembled in a backlight device as shown in FIG. 5 similar to Embodiment 1, and the brightness measurement was performed. As a result, the in-plane average brightness was 9348 cd/m².

### Embodiment 3

A stamper (hereinafter referred to as stamper 5) on the bottom surface side, in which prism patterns each having 0.007 mm in height and 120° in top angle were arranged at predetermined intervals, was made by forming V-shaped concave stripes each having the top angle of 120° and the height of 0.007 mm in a mold insert directly by use of a diamond bit through a cutting process, performing direct electroforming from the mold insert to form a nickel electroformed layer, and removing the master.

As molds for transferring, the stampers 3, 5 were assembled in a mold-stationary side cavity and a mold-movable side cavity of an injection machine, and a light-guiding plate for a 40 inch-liquid crystal television, having a fine structure was acquired through an injection forming process. The outside size of the obtained light-guiding plate was formed to have 900 mm×511 mm×4 mm in width, length and height, respectively. The obtained light-guiding plate was formed to have a mirror exit surface and a bottom surface having V-shaped convex stripes. Each of the V-shaped convex stripes was formed to have 0.007 mm in height and 30° in average angularity R of an inclined surface corresponding to an average bottom angle in each of the concave stripes parallel to the X-axis in an incident end surface side, to the bottom surface. The pitches of the V-shaped concave stripes were changed to be gradually and gently decreased from 0.446 mm in the incident end surfaces side to 0.179 mm in the central portion. The light-guiding plate was assembled in a backlight device as shown in FIG. 5 similar to Embodiment 1, and the brightness measurement was performed. As a result, the in-plane average brightness was 8943 cd/m².

### Embodiment 4

Similar to Embodiment 1, V-shaped concave stripes each having 0.007 mm in height and 140° in top angle were directly formed in a mold insert by use of a diamond bit through a cutting process, and electroforming was directly performed from the cut insert to form a nickel electroformed layer. By removing the master, a stamper 10 of the bottom surface side in which prism patterns each having 0.007 mm in height and 140° in top angle were arranged at predetermined intervals was formed.

As molds for transferring, the stamper 3 having on the exit surface side the convex stripes each having a trapezoidal shape in section used in Embodiment 2 and the stamper 10 were assembled in a mold-stationary side cavity and a mold-movable side cavity of an injection machine, and a light-guiding plate for a 40 inch-liquid crystal television having a fine structure was acquired through an injection forming process. The outside size of the obtained light-guiding plate was formed to have 900 mm×511 mm×4 mm in width, length and height, respectively.

The obtained light-guiding plate was formed to have an exit surface in which convex stripes each having a trapezoidal shape in section were arranged at predetermined pitches and a bottom surface in which concave stripes each having a V-shape in section were arranged at predetermined pitches. The trapezoidal convex stripe of the exit surface was formed to have 0.01 mm in height H, 0.01 mm in width W2 of the top portion, and 0.024 mm in bottom surface width W1. The V-shaped concave stripe of the bottom surface was formed to have 0.007 mm in height and 20° in average angularity R of an inclined surface corresponding to an average bottom angle in each of the concave stripes parallel to the X-axis in an incident end surface side, to the bottom surface. The obtained pitch was gradually and gently reduced from 0.446 mm in the incident end surface side to 0.179 mm in the central portion. The light-guiding plate was assembled in a backlight device as shown in FIG. 5, similar to Embodiment 1, and the brightness measurement was performed. As a result, the in-plane average brightness was 9175 cd/m².

### Embodiment 5

A stamper (hereinafter referred to as stamper 6) on the exit surface side, in which trapezoidal patterns each having 0.01 mm in height, about 0.01 mm in width in the flat portion of the top portion, and 55° in inclined angle were formed, was made through a process similar to that of the stamper formed in Embodiment 1.

A stamper (hereinafter referred to as stamper 7) of the bottom surface side, in which prism patterns each having 0.005 mm in height and 130° in top angle were arranged at predetermined intervals, was made by forming V-shaped concave stripes each having the top angle of 130° and the height of 0.005 mm in a mold insert directly by use of a diamond bit through a cutting process, performing direct electroforming from the cut insert to form a nickel electroformed layer, and removing the master.

As molds for transferring, the stampers 6, 7 were assembled in a mold-stationary side cavity and a mold-movable side cavity of an injection machine, and a light-guiding plate for a 46 inch-liquid crystal television having a fine structure was acquired through an injection forming process. The outside size of the obtained light-guiding plate was formed to have 1040 mm×598 mm×4 mm in width, length and height, respectively.

The obtained light-guiding plate was formed to include an exit surface in which convex stripes each having a trapezoidal shape in section were arranged at predetermined pitches and a bottom surface in which concave stripes each having a V-shape in section were arranged at predetermined pitches. The trapezoidal convex stripe of the exit surface was formed to have 0.01 mm in height H, 0.01 mm in width W2 of the top portion, and 0.024 mm in bottom surface width W1. The V-shaped concave stripe of the bottom surface was formed to have 0.005 mm in height and 30° in average angularity R of an inclined surface corresponding to an average bottom angle in each of the concave stripes parallel to the X-axis in an incident end surface side, to the bottom surface. The pitch was changed to be gradually and gently reduced from of 1.037 mm in the incident end surface side to 0.581 mm in the central portion, and was gradually and gently increased to 0.620 mm in the reflection and incident end face side from the central portion.

A multi-chip LED module (light-emitting element: 20, outside size: 13.7 mm and light-emitting length: 11.4 mm) of model No. SEP0HA6007 made by Sanken Electric Co., Ltd. was used as a light-emitting unit. In order to form a primary light source, 75 light-emitting units were directly aligned at equal intervals (13.9 mm). V-shaped concave stripes were arranged on the bottom surface of the light-guiding plate to be parallel to the X-axis, and the primary light sources were disposed only in one end surface parallel to the X-axis.

In addition, one diffusion sheet (model No. D121UZ made by Tsujiden Co. LTD.) was disposed above the exit surface of the light-guiding plate, and a brightness-up film (model No. BEF III-90/50T-7 made by Sumitomo 3M Ltd.) was further disposed so that long sides of prisms are parallel to the X-axis, and a diffusion sheet (model No. PBS072H made by Keiwa Inc.) was further disposed on the brightness-up film.

In addition, a reflection sheet 5 (model No. E6SL made by Toray Industries, Inc.) was disposed on a bottom surface 7 of the light-guiding plate and a mirror surface reflection sheet (model No. RAYLA NR3 made by Keiwa Inc.) was disposed in a reflection and incident end surface 8a. These parts were contained in a metallic frame.

A supporting frame made of polystyrene was disposed from above the metallic frame and combined to the metallic frame located on a back surface of the supporting frame.

In the backlight device thus formed and illustrated in FIG. 7, brightness performance was measured by applying the current of 24V, 7A from a stabilized power supply. A brightness meter (TOPCON BM-7 made by Topcon Corporation) was used for the brightness measurement, and 9 points illustrated in FIG. 6 were measured. As a result, the in-plane average brightness was 7967 cd/m².

### Embodiment 6

Similar to Embodiment 1, V-shaped concave stripes each having 0.007 mm in height and 125° in top angle were directly formed in a mold insert by use of a diamond bit through a cutting process, and electroforming was directly performed from the cut insert to form a nickel electroformed layer. By removing the master, a stamper 13 of the bottom surface side, in which prism patterns each having 0.007 mm in height and 125° in top angle were arranged at predetermined intervals, was formed.

As molds for transferring, the stamper 3 having on the exit surface side the convex stripes each having a trapezoidal shape in section used in Embodiment 2 and stamper 13 were assembled in a mold-stationary side cavity and a mold-movable side cavity of an injection machine, and a light-guiding plate for a 40 inch-liquid crystal television having a fine structure was acquired through an injection forming process. The outside size of the obtained light-guiding plate was formed to have 900 mm×511 mm×4 mm in width, length and height, receptively.

The obtained light-guiding plate was formed to have an exit surface in which convex stripes each having a trapezoidal shape in section were arranged at predetermined pitches and a bottom surface in which concave stripes each having a V-shape in section were arranged at predetermined pitches. The trapezoidal convex stripe of the exit surface was formed to have 0.01 mm in height H, 0.01 mm in width W2 of the top portion, and 0.024 mm in bottom surface width W1. The V-shaped concave stripe of the bottom surface was formed to have 0.007 mm in height and 27.5° in average angularity R of an inclined surface corresponding to an average bottom angle in each of the concave stripes parallel to the X-axis in an incident end surface side, to the bottom surface. The obtained pitch was gradually and gently reduced from 0.446 mm in the incident end surface side to 0.179 mm in the central portion. The light-guiding plate was assembled in a backlight device as shown in FIG. 5, similar to Embodiment 1, and the brightness measurement was performed. As a result, the in-plane average brightness was 9150 cd/m².

### Embodiment 7

Similar to Embodiment 5, V-shaped concave stripes each having 0.005 mm in height and 125° in top angle were directly formed in a mold insert by use of a diamond bit through a cutting process, and electroforming was directly performed from the cut insert to form a nickel electroformed layer. By removing the master, a stamper 14 of the bottom surface side in which prism patterns each having 0.005 mm in height and 125° in top angle were arranged at predetermined intervals was formed.

As molds for transferring, the stamper 6 having on the exit surface side the convex stripes each having a trapezoidal shape in section used in Embodiment 5 and stamper 14 were assembled in a mold-stationary side cavity and a mold-movable side cavity of an injection machine, and a light-guiding plate for a 46 inch-liquid crystal television having a fine structure was acquired through an injection forming process. The outside size of the obtained light-guiding plate was formed to have 1040 mm×598 mm×4 mm in width, length and height, respectively.

The obtained light-guiding plate was formed to have an exit surface in which convex stripes each having a trapezoidal shape in section were arranged at predetermined pitches and a bottom surface in which concave stripes each having a V-shape in section were arranged at predetermined pitches. The trapezoidal convex stripe of the exit surface was formed to have 0.01 mm in height H, 0.01 mm in width W2 of the top portion, and 0.024 mm in bottom surface width W1. The V-shaped concave stripe of the bottom surface was formed to have 0.005 mm in height and 27.5° in average angularity R of an inclined surface corresponding to an average bottom angle in each of the concave stripes parallel to the X-axis in an incident end surface side, to the bottom surface. The obtained pitch was changed to be gradually and gently reduced from 1.037 mm in the incident end surface side to 0.581 mm in the central portion. The light-guiding plate was assembled in a backlight device as shown in FIG. 7 similar to Embodiment 5, and the brightness measurement was performed. As a result, the in-plane average brightness was 8135 cd/m².

### Embodiment 8

Similar to Embodiment 5, V-shaped concave stripes each having 0.005 mm in height and 140° in top angle were directly formed in a mold insert by use of a diamond bit through a cutting process, and electroforming was directly performed from the cut insert to form a nickel electroformed layer. By removing the master, a stamper 15 of the bottom surface side in which prism patterns each having 0.005 mm in height and 140° in top angle were arranged at predetermined intervals was formed.

As molds for transferring, the stamper 6 having on the exit surface side the convex stripes each having a trapezoidal shape in section used in Embodiment 5 and the stamper 15 were assembled in a mold-stationary side cavity and a mold-movable side cavity of an injection machine, and a light-guiding plate for a 46 inch-liquid crystal television having a fine structure was acquired through an injection forming process. The outside size of the obtained light-guiding plate was formed to have 1040 mm×598 mm×4 mm in width, length and height, respectively.

The obtained light-guiding plate was formed to have an exit surface in which convex stripes each having a trapezoidal shape in section were arranged at predetermined pitches and a bottom surface in which concave stripes each having a V-shape in section were arranged at predetermined pitches. The trapezoidal convex stripe of the exit surface was formed to have 0.01 mm in height H, 0.01 mm in width W2 of the top portion, and 0.024 mm in bottom surface width W1. The V-shaped concave stripe of the bottom surface was formed to have 0.005 mm in height and 20° in average angularity R of an inclined surface corresponding to an average bottom angle in each of the concave stripes parallel to the X-axis in an incident end surface side, to the bottom surface. The obtained pitch was changed to be gradually and gently reduced from 1.037 mm in the incident end surface side to 0.581 mm in the central portion, and to be gradually and gently increased from the central portion to 0.620 mm in the reflection and incident end surface side. The light-guiding plate was assembled in a backlight device as shown in FIG. 7 similar to Embodiment 5, and the brightness measurement was performed. As a result, the in-plane average brightness was 8154 cd/m².

### COMPARISON EXAMPLE 1

The comparison example is an example of a case where the average angularly R of the V-shaped concave stripe provided in the bottom surface of the light-guiding plate for use in Embodiment 1 is 40°.

Similar to Embodiment 1, a nickel electroformed layer was formed by making directly V-shaped concave stripes each having 0.007 mm in height and 100° in top angle in a mold insert by use of a diamond bit through a cutting process, and performing direct electroforming from the cut insert. By removing the master, a stamper 8 of the bottom surface side in which prism patterns each having 0.007 mm in height and 100° in top angle were arranged at predetermined intervals was formed.

As molds for transferring, the stamper 1 used in Embodiment 1 and the stamper 8 were assembled in a mold stationary side cavity and a mold movable side cavity of an injection machine, and a light-guiding plate having a fine structure for a 40 inch-liquid crystal television was obtained by use of an injection molding process. The obtained light-guiding plate was formed to have the outside size of 900 mm×511 mm×4 mm in width, length and height, respectively.

The light-guiding plate was adjusted to have an exit surface formed in a mirror surface and a bottom surface in which the concave stripes each having a V-shape in section were arranged from the incident end surface of the light-guiding plate. Each of the concave stripes each having a V-shape in section on the bottom surface of the light-guiding plate was formed to have 0.007 mm in height and 40° in average angularity R of an inclined surface corresponding to an average bottom angle in each of the concave stripes parallel to the X-axis in an incident end surface side, to the bottom surface. The obtained pitches were gradually and gently decreased from 0.470 mm in the incident end surface to 0.199 mm in the central portion.

The light-guiding plate was assembled in a backlight device as shown in FIG. 5, similarly to Embodiment 1 to measure the brightness. As a result, the in-plane average brightness was 7875 cd/m², which was decreased by 7.6% compared to the light-guiding plate of Embodiment 1.

### COMPARISON EXAMPLE 2

The comparison example is an example of a case where the average angle of the V-shaped concave stripe provided in the bottom surface of the light-guiding plate used in the embodiment 2 is 40°. Similarly to Embodiment 1, a nickel electroformed layer was formed by making directly V-shaped concave stripes each having 0.020 mm in height and 100° in top angle in a mold insert by use of a diamond bit through a cutting process, and performing direct electroforming from the cut insert. By removing a master, a stamper 9 of the bottom surface side in which prism patterns each having 0.020 mm in height and 100° in top angle were arranged at predetermined intervals was manufactured.

As molds for transferring, the stamper 3 used in Embodiment 2 and forming the patterns of convex stripes each having a trapezoidal shape in section on the exit surface side and the stamper 9 were assembled in a mold stationary side cavity and a mold movable side cavity of an injection machine, and a light-guiding plate having a fine structure for a 40 inch-liquid crystal television was obtained by use of an injection molding process. The obtained light-guiding plate was formed to have the outside size of 900 mm×511 mm×4 mm in width, length and height, respectively.

The obtained light-guiding plate was adjusted to have an exit surface on which the convex stripes each having a trapezoidal shape in section were formed at intervals and concave stripes each having a V-shape in section to be arranged from the incident end surface of the light-guiding plate. Each of the trapezoidal convex stripes on the exit surface was formed to have a size in which the height H is 0.01 mm, the width W2 of the top portion is 0.01 mm and the width W1 of the bottom surface is 0.024 mm. Each of the V-shaped concave stripes on the bottom surface was formed to have 0.020 mm in height, and 40° in average angularity R of an inclined surface corresponding to an average bottom angle in each of the concave stripes parallel to the X-axis in an incident end surface side, to the bottom surface. The pitches were reduced progressively and gradually from 0.994 mm in the incident end surface side to 0.358 mm in the central portion. The light-guiding plate was assembled in a backlight device as shown in FIG. 5 similar to Embodiment 1, and the brightness was measured. As a result, the in-plane average brightness was 8457 cd/m² which was lowered at 9.5% compared to the light-guiding plate of Embodiment 2.

### COMPARISON EXAMPLE 3

The comparison example is an example of a case where the average angularity of the V-shaped concave stripe provided in the bottom surface of the light-guiding plate for use in Embodiment 2 is 15°.

Similar to Embodiment 1, a nickel electroformed layer was formed by making directly V-shaped concave stripes each having 0.007 mm in height and 150° in top angle in a mold insert by use of a diamond bit through a cutting process, and performing direct electroforming from the cut insert. By removing the master, a stamper 11 of the bottom surface side in which prism patterns each having 0.007 mm in height and 150° in top angle were arranged at predetermined intervals was manufactured.

As molds for transferring, the stamper 3 used in Embodiment 2 and forming trapezoidal convex patterns in section on the exit surface and the stamper 11 were assembled in a mold stationary side cavity and a mold movable side cavity of an injection machine, and a light-guiding plate having a fine structure for a 40 inch-liquid crystal television was obtained by use of an injection molding process. The obtained light-guiding plate was formed to have the outside size of 900 mm×511 mm×4 mm in width, length and height, respectively.

The obtained light-guiding plate was formed to have an exit surface on which the trapezoidal convex stripes in section were arranged at intervals and a bottom surface in which the V-shaped concave stripes in section were arranged at predetermined pitches. Each of the trapezoidal convex stripes on the exit surface was formed to have a size in which the height is 0.01 mm, the width W2 of the top portion is 0.01 mm and the width W1 of the bottom surface is 0.024 mm, the height of each V-shaped concave stripes on the bottom surface is 0.007 mm, and the average angularity of 15° of an inclined surface corresponding to an average bottom angle in each of the concave stripes parallel to the X-axis in an incident end surface side, to the bottom surface. The obtained pitches were reduced progressively and gradually from 0.446 mm in the incident end surface side to 0.179 mm in the central portion.

The light-guiding plate was assembled in a backlight device as shown in FIG. 5, similarly to Embodiment 1, and the brightness was measured. As a result, the in-plane average brightness was 8686 cd/m², which was lowered by 7% compared to Embodiment 2.

### COMPARISON EXAMPLE 4

The comparison example is an example of a case where the average angularity of the V-shaped concave stripe provided in the bottom surface of the light-guiding plate for use in Embodiment 5 is 40°.

Similar to Embodiment 1, a nickel electroformed layer was formed by making directly V-shaped concave stripes each having 0.005 mm in height and 100° in top angle in a mold insert by use of a diamond bit through a cutting process, and performing direct electroforming from the cut insert. By removing the master, a stamper 12 of the bottom surface side in which prism patterns each having 0.005 mm in height and 100° in top angle were arranged at predetermined intervals was manufactured.

As molds for transferring, the stamper 6 and the stamper 12 were assembled in a mold stationary side cavity and a mold movable side cavity of an injection machine, and a light-guiding plate having a fine structure for a 46 inch-liquid crystal television was obtained by use of an injection molding process. The obtained light-guiding plate was formed to have the outside size of 1040 mm×598 mm×4 mm in width, length and height, respectively.

The obtained light-guiding plate was formed to have an exit surface on which the trapezoidal convex stripes in section were arranged at intervals and a bottom surface in which the V-shaped concave stripes in section were arranged at predetermined pitches. Each of the trapezoidal convex stripes on the exit surface was formed to have a size in which the height is 0.01 mm, the width W2 of the top portion is 0.01 mm and the width W1 of the bottom surface is 0.024 mm, the height of each V-shaped concave stripe is 0.005 mm, and the average angularity of 40° of an inclined surface corresponding to an average bottom angle in each of the concave stripes parallel to the X-axis in an incident end surface side, to the bottom surface.

The pitches were changed to be reduced progressively and gradually from 0.897 mm in the incident end surface side to 0.519 mm in the central portion, and were increased progressively and gradually to 0.597 mm in the reflection and incident end surface side from the central portion.

The light-guiding plate was assembled in a backlight device as shown in FIG. 7, similarly to Embodiment 5, and the brightness was measured. As a result, the in-plane average brightness was 7484 cd/m², which was lowered by 6% compared to the light-guiding plate of Embodiment 5.

### COMPARISON EXAMPLE 5

This comparison example is an example of a case in which a light-guiding plate was formed by applying printing dots on a bottom surface of a flat plate (4 mm in thickness) made of PMMA, and the light-guiding plate was assembled to a backlight of Embodiment 1.

The bottom surface of the light-guiding plate had white printing dots in which the density of the dots was increased with the increasing distance from the incident end face side (large dot density in the central portion of the light-guiding plate), and the brightness distribution was predetermined.

The light-guiding plate was assembled in a backlight device as shown in FIG. 5, similarly to Embodiment 1, and the brightness was measured. As a result, the in-plane average brightness was 8054 cd/m², which was lowered by 13.8% compared to the light-guiding plate of Embodiment 2. When it is compared to the light-guiding plate of Embodiment 3, it was lowered by 10% in the in-plane average brightness.

### COMPARISON EXAMPLE 6

This comparison example is an example of a case in which a light-guiding plate was formed by applying printing dots on a bottom surface of a flat plate (4 mm in thickness) made of PMMA, similar to Embodiment 5, and the light-guiding plate was assembled to a backlight of Embodiment 5. The bottom surface of the light-guiding plate had white printing dots in which the density of the dots was increased with the increasing distance from the incident end face side, and the brightness distribution was predetermined distribution.

The light-guiding plate was assembled in a backlight device as shown in FIG. 7, similar to Embodiment 5, and the brightness was measured. As a result, the in-plane average brightness was 7568 cd/m², which was lowered by 5% compared to the light-guiding plate of Embodiment 5.

### COMPARISON EXAMPLE 7

The comparison example is an example of a case where the average angularity of the V-shaped concave stripe provided in the bottom surface of the light-guiding plate for use in Embodiment 5 is 15°.

Similar to Embodiment 5, a nickel electroformed layer was formed by making directly V-shaped concave stripes each having 0.005 mm in height and 150° in top angle in a mold insert by use of a diamond bit through a cutting process, and performing direct electroforming from the cut insert. By removing the master, a stamper 16 of the bottom surface side in which prism patterns each having 0.005 mm in height and 150° in top angle were arranged at predetermined intervals was manufactured.

As molds for transferring, the stamper 6 and the stamper 16 were assembled in a mold stationary side cavity and a mold movable side cavity of an injection machine, and a light-guiding plate having a fine structure for a 46 inch-liquid crystal television was obtained by use of an injection molding process. The obtained light-guiding plate was formed to have the outside size of 1040 mm×598 mm×4 mm in width, length and height, respectively.

The obtained light-guiding plate was formed to have an exit surface on which the trapezoidal convex stripes in section were arranged at intervals and a bottom surface in which V-shaped concave stripes in section were arranged at predetermined pitches. Each of the trapezoidal convex stripes on the exit surface was formed to have a size in which the height is 0.01 mm, the width W2 of the top portion is 0.01 mm and the width W1 of the bottom surface is 0.024 mm, the height of each V-shaped concave stripe on the bottom surface is 0.005 mm, and the average angularity of 15° of an inclined surface corresponding to an average bottom angle in each of the concave stripes parallel to the X-axis in an incident end surface side, to the bottom surface. The pitches were reduced progressively and gradually from 1.037 mm in the incident end surface side to 0.581 mm in the central portion. It is increased progressively and gradually to 0.620 mm from the central portion to the reflection and incident end face side.

The light-guiding plate was assembled in a backlight device as shown in FIG. 7, similarly to Embodiment 5, and the brightness was measured. As a result, the in-plane average brightness was 7572 cd/m², which was lowered by 5% compared to Embodiment 5.

### COMPARISON EXAMPLE 8

The comparison example is an example of a case in which the optical sheets provided on the exit surface of the light-guiding plate for use in Embodiment 2 are two diffusion sheets.

Similar to Embodiment 1, the prism sheet 5b was removed from the backlight device illustrated in FIG. 5, and one diffusion sheet (model No. D121UZ made by Tujiden, Ltd.) was placed on the exit surface of the light-guiding plate for use in Embodiment 2, and a diffusion sheet (model No. D121UZ made by Keiwa inc.) was placed on that, and the brightness measurement was performed. As a result, the in-plane average brightness was 7852 cd/m², which was lowered at 16% compared to Embodiment 2.

1. An edge-light type surface light source element, comprising:
a light-guiding plate including a side surface having at least one primary light source, an exit surface, a bottom surface opposite to the exit surface, and an incident end surface from which light emitted from the primary light source provided in the side surface enters;
a reflector provided on the bottom surface side of the light guiding plate, and configured to reflect light; and
one optical sheet or a plurality of optical sheets provided on the exit surface side of the light-guiding plate, wherein
if a normal line of an X-Y plane formed by an X-axis and a Y-axis orthogonal to the X-axis is a Z-axis,
the primary light source is arranged parallel to the X-axis,
the reflector, the light-guiding plate and the optical sheet are arranged parallel to the X-Y plane, and
the reflector, the light-guiding plate and the optical sheet are arranged in order in the Z-axis direction,
the optical sheets include at least one prism sheet,
an exit surface of a prism sheet closest to the exit surface of the light-guiding plate includes a convex stripe prism, and a longitudinal direction of the convex stripe prism is arranged parallel to the X-axis,
the incident end surface of the light-guiding plate is parallel to the X-Z plane, the bottom surface includes a pattern having a plurality of concave stripes parallel to the X-axis, and each of the concave stripes includes an inclined surface parallel to the X-axis on the incident end surface side, and
an angularity R of the inclined surface to the bottom surface of the light-guiding plate satisfies the following conditions,
R≦{π/2−sin⁻¹(0.422/n_{LGP})}/2
R≧sin⁻¹(1/n_{LGP})−sin⁻¹(0.643/n_{LGP})
R: the average angularity (radian) to the bottom surface of the light-guiding plate,
n_{LGP}: a refractive index of a base material of the light guiding plate.

2. The edge-light type surface light source element according to claim 1, wherein the primary light source is arranged in each of the opposite two incident end surfaces, and each of the plurality of concave stripes has the inclined surface parallel to the X-axis relative to the two incident end surfaces.

3. The edge-light type surface light source element according to claim 1, wherein the concave stripe formed on the bottom surface of the light-guiding plate includes a V shape in section.

4. The edge-light type surface light source element according to claim 1, wherein the concave stripe formed on the bottom surface of the light-guiding plate includes a trapezoidal shape in section.

5. The edge-light type surface light source element according to claim 1, wherein the exit surface of the light-guiding plate includes a pattern having a plurality of convex stripes parallel to the Y-axis.

6. The edge-light type surface light source element according to claim 5, wherein the convex stripe formed on the exit surface of the light-guiding plate includes a trapezoidal shape in section.

7. The edge-light type surface light source element according to claim 1, wherein the concave stripe formed on the bottom surface of the light-guiding plate includes a V-shape in section, the exit surface of the light-guiding plate includes a pattern in which a plurality of convex stripes parallel to the Y-axis is arranged at intervals, and the convex stripe includes a trapezoidal shape in section.

8. The edge-light type surface light source element according to claim 1, wherein the optical sheets include a diffusion sheet, a prism sheet, and a diffusion sheet sequentially arranged above the exit surface of the light-guiding plate.

9. The edge-light type surface light source element according to claim 1, wherein the optical sheets include a diffusion sheet, a prism sheet, a reflection type polarization film sequentially arranged above the exit surface of the light-guiding plate.

10. An image display comprising a transmission-type display element on the exit surface side of the surface light source element according to claim 1.
